(19) United States
(12) Patent Application Publication
(10) Pub. No.: US 2012/0166308 A1
(43) Pub. Date: Jun. 28, 2012

(54) METHOD AND APPARATUS IN-APPLICATION PURCHASING

(75) Inventors: Zahid AHMED, Westborough, MA (US); Mario CARDONA, Coppell, TX (US); Eli ENTIN, New York, NY (US); Bogdan-Paul DOBRIN, Helsinki (FI); Harsha Ramamurthy JOSHI, Bangalore (IN); Sami Mikael PUURA, Helsinki (FI)

(73) Assignee: NOKIA CORPORATION, Espoo (FI)

(21) Appl. No.: 13/174,709

(22) Filed: Jun. 30, 2011

Related U.S. Application Data
(60) Provisional application No. 61/360,168, filed on Jun. 30, 2010.

(51) Int. Cl. G06Q 30/06

(52) U.S. Cl. 705/26.41

(57) ABSTRACT

Techniques for purchasing items within an application on user equipment comprises determining at a network service store that a first message is received through a communications network from an application on user equipment. The message indicates a first item to purchase. A publisher different from the network service store has granted approval to use the application on the user equipment. The network service store determines whether payment is arranged from a user of the user equipment to pay for the first item. If payment is arranged, then the network service store causes, at least in part, actions that result in approval from the publisher to use the first item on the user equipment.

### RELATED APPLICATION

This application claims priority benefit from U.S. Provisional Application No. 61/360,168, filed Jun. 30, 2010, which is hereby incorporated in its entirety by reference.

### BACKGROUND

Service providers and device manufacturers (e.g., wireless, cellular, etc.) are continually challenged to deliver value and convenience to consumers by, for example, providing compelling network services and applications for consumer devices. To encourage consumers to try services and applications based on software on a user device, a portion of the software is licensed for a small or free introductory rate. The user can then add features, sometimes including additional portions of software, at additional costs. Each of these purchases involves another transaction with the publisher of the software. For many applications from many publishers, the user is often forced to create accounts with multiple publishers. This practice is wasteful of computational operations and time on the user device and wasteful of bandwidth on a communications network. Some retail network services retail software from multiple publishers, but require the user exit the application being run to contact the retail service and purchase the upgrade for the application. Then the user must re-initiate the application. This is again wasteful of computational operations and time on the user equipment.

### SOME EXAMPLE EMBODIMENTS

Therefore, there is a need for an approach for adding paid features of a software application on a user device without exiting the application, a process called herein in-application purchasing (IAP), which does not suffer one or more of the disadvantages of prior approaches.

According to one embodiment, a method comprises determining at a network service store that a first message is received through a communications network from an application on user equipment. The message indicates a first item to be purchased. The method further comprises determining at the network service store whether payment is arranged from a user of the user equipment to pay for the first item. The method also comprises causing, at least in part, actions that result in approval from a publisher to use the first item on the user equipment, if payment is arranged.

According to another embodiment, a method of an application executing on user equipment comprises, determining a plurality of items associated with the application. The method further comprises causing, at least in part, actions that result in presenting the plurality of items to a user of the user equipment. The method also comprises determining whether the user has selected a first item of the plurality of items to purchase. The method still further comprises causing, at least in part, actions that result in sending a message to the network service store, if the user has selected the first item to purchase. The message indicates a request to purchase the first item.

According to another embodiment, an apparatus comprises at least one processor, and at least one memory including computer program code, the at least one memory and the computer program code configured to, with the at least one processor, cause, at least in part, the apparatus to perform one or more steps of one of the above methods.

According to another embodiment, a computer-readable storage medium carrying one or more sequences of one or more instructions which, when executed by one or more processors, cause, at least in part, an apparatus to perform one or more steps of one of the above methods.

According to another embodiment, an apparatus comprises means for performing one or more steps of one of the above methods.

According to various other embodiments, a computer program product includes one or more sequences of one or more instructions which, when executed by one or more processors, cause an apparatus to at least perform one or more steps of one of the above methods.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of in-application purchasing, according to one embodiment;

FIGS. 2A through 2E are diagrams of example data structures utilized to associated an application with items to be purchased through the application, according to one embodiment;

FIG. 3 is a time sequence diagram that depicts a sequence of messages and actions at various processes in a communication network for in-application purchasing, according to one embodiment;

FIG. 4 is a flowchart of a process on an in-application purchasing client, according to one embodiment;

FIG. 5 is a flowchart of a process on an in-application purchasing service, according to one embodiment;

FIGS. 6A-6E are diagrams of user interfaces utilized in the processes of FIG. 4, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program are disclosed for in-application purchasing. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term subscription service refers to any paid service available through an communications network, such as music download, photograph download, video download, television shows, news, games, virus protection and other security services, banking, trading and other financial services, social networking services, among many others. The term application, as used herein, refers to a process, typically implemented in software (described in more detail below), which operates on a user device. The software for the application is downloaded from an applications service, for free or for a payment. In some embodiments, the application may communicate with the application service or a subscription service during operation of the application. Thus an application refers to a stand-alone process on a user equipment or a client process on the user equipment interacting with an unpaid service or a subscription service. As used herein, the term publisher refers to an owner of the rights to the application. The publisher has the legal authority to grant, to a user, a license to use the application.

Although various embodiments are described with respect to downloading additional game levels from a game service, it is contemplated that the approach described herein may be used with other applications, application services, and subscription services. Often the user pays the publisher a fee for the license. The fee, if demanded by the publisher, may be paid to the publisher directly, or indirectly to a third party, such as a retail network service (called a network store, herein) or network operator. A network operator grants to a user access for user equipment to a communications network used to communicate with the network store or other network service.

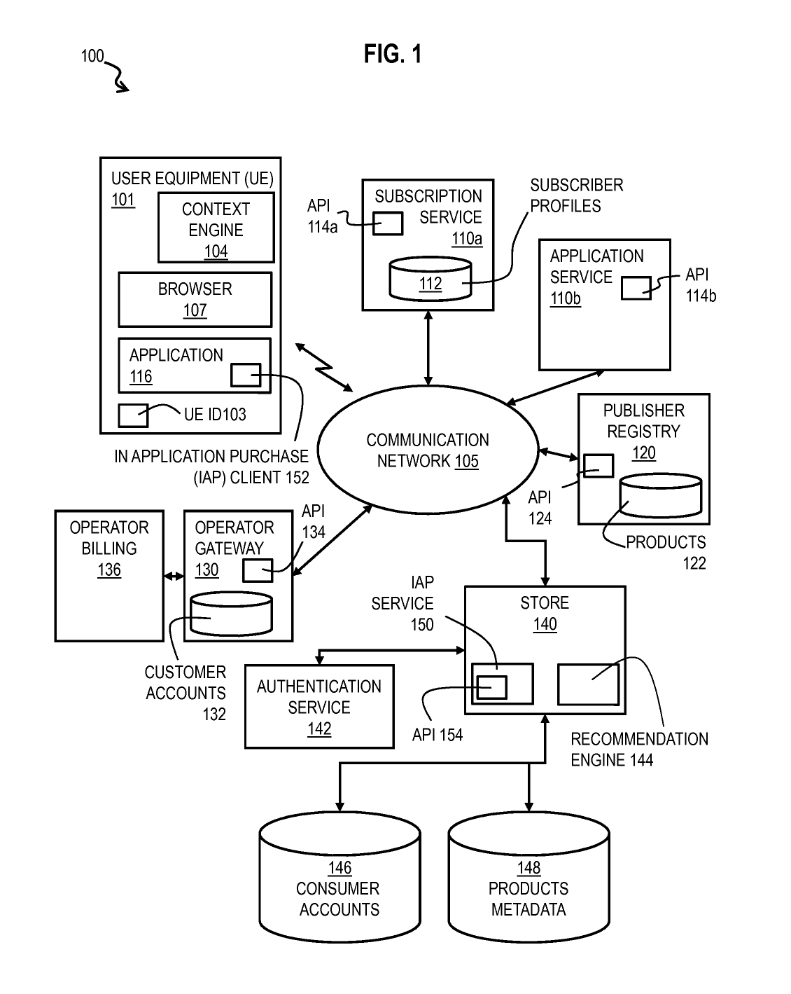

FIG. 1 is a diagram of a system 100 capable of in-application purchasing (IAP), according to one embodiment. When a developer produces an application for installation on a user device, such as user equipment 101, it is sometime desirable to offer a portion of the application at an introductory price, including for free, and add one or more other features of the application at additional prices. This allows a user to become familiar with a product before committing noticeable amounts of money to it. If the user likes the product, then the user is more likely to purchase the additional features. If charged initially the same amount, the user might be reluctant to even try the product.

However, it is difficult for the application developer to control the incremental addition of features because the developer does not usually interact directly with the user. The developer sells or licenses the application to a publisher which gives notice on a communications network of the availability of the application. In some cases, the developer and publisher are the same legal entity. Users may prefer not to set up multiple accounts to buy applications from multiple publishers and manage multiple login procedures and passwords. Network service stores are more convenient for the user. With one account at the network service store, the user can purchase all the products offered for retail by the store, including products of multiple publishers. Currently, however, many such network service stores do not permit the application to control the selection and purchase of features associated with the application. This forces the developer to produce different versions of the application for sale at different prices; and removes the purchase decision from a time during the execution of the application when a user is more likely to determine a desire for the extra features and thus experience a willingness to pay an extra fee. The result is more consumption of computational resources on the developers' devices; and, often, more advertising traffic to induce the same number of sales, which is wasteful of network bandwidth and computational resources on the user devices of hundreds of users.

To address this problem, a system 100 of FIG. 1 introduces the capability for in-application purchases (TAP). The system 100 includes an IAP service module 150 in a network service store 140 (also called store 140, for convenience), and an IAP client module 152 within the application 116 installed on user equipment 101. The network retail store 140 communicates with a publisher registry service 120 of the publisher of application 116, as well as an operator gateway 130 of the operator that provides network access to the UE 101. The publisher registry 120 includes a products data structure 122 that lists all the products of the publisher, such as subscription service 110a and application service 110b (collectively referenced hereinafter as publisher services 110). Some subscription services use a standard browser and not an application purchased from the publisher as the user equipment client process; nonetheless such subscription services are considered products for the purposes of this application.

The IAP client 152 and IAP service 150 communicate to identify items associated with the application 116 that can be purchased, to indicate an item to be purchased, and to execute payment so that the item can be delivered to the application 116 on UE 101. As used herein, an item refers to a feature of the application 116 or a different application or different subscription service available from the same publisher, or a feature or different application or different subscription service available from a different publisher known to the store 140.

As shown in FIG. 1, the system 100 comprises user equipment (UE) 101 having connectivity to publisher services 110 and operator gateway 130 and network store 140 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), Integrated Digital Enhanced Network (iDEN) and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, publisher services 110 and store 140 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

Processes executing on various devices, often communicate using the client-server model of network communications, widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host on which the process operates. Similarly, the term “client” is conventionally used to refer to the process that makes the request, or the host on which the process operates. As used herein, the terms “client” and “server” refer to the processes, rather than the hosts, unless otherwise clear from the context. In addition, the process performed by a server can be broken up to run as multiple processes on multiple hosts (sometimes called tiers) for reasons that include reliability, scalability, and redundancy, among others. A well known client process available on most nodes connected to a communications network is a World Wide Web client (called a “web browser,” or simply “browser”) that interacts through messages formatted according to the hypertext transfer protocol (HTTP) with any of a large number of servers called World Wide Web (WWW) servers that provide web pages.

In the illustrated embodiment, the UE 101 includes a browser 107 and an application 116 and a context engine 104. The context engine 104 determines the local context of UE 101 and any user thereof, such as local time, geographic position from a positioning system, ambient temperature, pressures, sound and light, and applications currently executing on UE 101, content currently being rendered on UE 101, and user input through a user interface (UI). In some embodiments, the application 116 is a client for at least one of the publisher services 110. In some embodiments, application 116 is script delivered through the browser 107.

The UE 101 also includes a data structure that stores data that indicates UE ID 103. In some embodiments, a subscription service 110a interacts with a user of UE 101 though the browser 107. In some embodiments, one or more of services 110 interact with a user of UE 101 though the application 116.

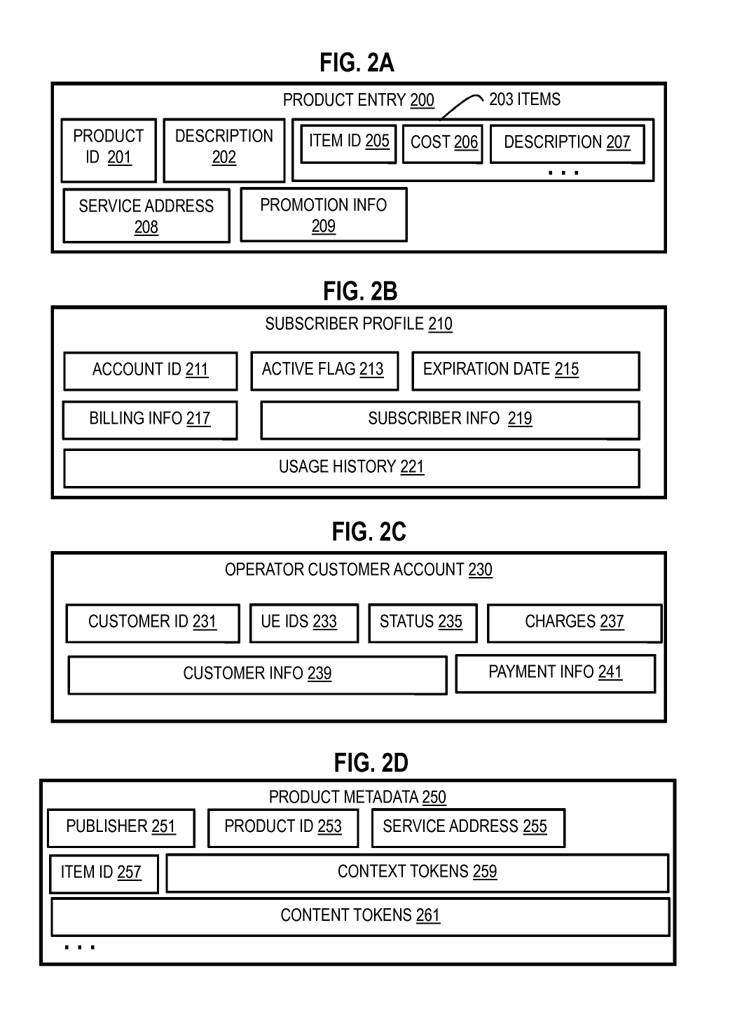

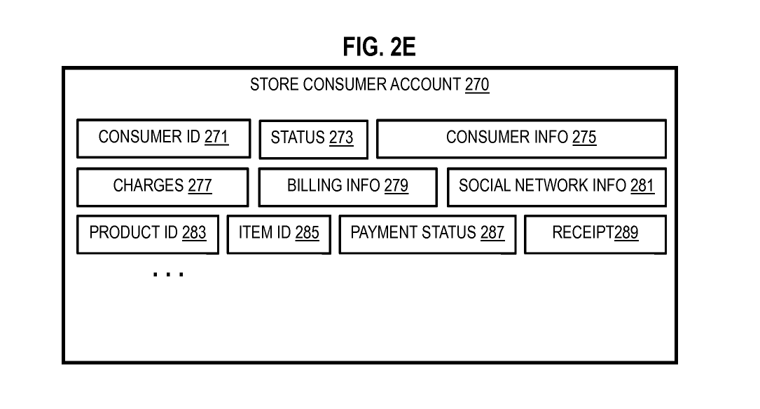

The subscription services 110a include subscriber profiles data structures 112. Each subscriber profiles data structure 112 holds data that indicates information about consumers who have subscribed to the service, as described in more detail below with reference to FIG. 2B. While the publisher services 110 interact with the UE 101 through HTTP messages with the browser 107 or messages of the same or different protocols with application 116, other services connected to communication network 105 can access the functionality of the publisher services 110 through corresponding application programming interfaces API 114a and API 114b, respectively. These API define parameters, acceptable ranges for values for the parameters, functions performed for certain values of parameters, and a protocol for exchanging the parameter values across network 105.

The operator provides the UE 101 with access to the communications network 105, often in collaboration with one or more other operators. Such access is set up through one or more operator gateway services 130, either directly in some embodiments, or indirectly through a point of sale service (not shown) provided by a retailer in other embodiments. The consumer information for a user of UE 101 (such as name, social security number, telephone number and billing address or bank account or credit card information) is stored in customer accounts data structure 132. The customer accounts also associates the consumer with the particular UE 101. The UE 101 is identified with a user equipment identifier (UE ID), such as an International Mobile Equipment Identity (IMEI) that is a number, usually unique, to identify GSM, WCDMA, iDEN and some satellite mobile phones. The operator gateway often provides billing services for one or more subscription services 110. In the illustrated embodiment, the operator gateway 130 is connected to an operator billing service 136, either directly, as depicted, or indirectly via network 105, to initiate payment from a consumer for use of network 105 and for use of any publisher services 110 or store 140 that use operator billing. Billing and other functions of operator gateway 130 are accessed through the operator gateway API 134.

In the illustrated embodiment, a publisher registry service 120 is included for each publisher of products, including applications for user equipment. The publisher registry service 120 maintains a products data structure 122 that holds data that indicates all the products offered by a corresponding publisher. The products, such as application 116 and publisher services 110, are thus associated with a publisher. Access to the information on the products data structure 122 is controlled to only privileged services. In some embodiments, access is obtained through a publisher registry API 124.

According to various embodiments, the system 100 includes the network service store 140. The store 140 is configured to accumulate, into products metadata data structure 148, information about the products for one or more publishers. For example, in some embodiments, information is obtained from the publisher registry service 120 and the services 110; and stored in data structure 148. The store 140 is also configured to accumulate into consumer accounts data structure 146, information about consumers who purchase products through the store 140. In some embodiments, consumers communicating with the store 140 are authenticated using an authentication service 142. In various embodiments, information in the consumer accounts data structure 146 or products metadata data structure 148, or both, is available through an IAP service API 154. In some embodiments the IAP client 152 on UE 101 is configured to send messages to the IAP service 150 in addition to or instead of sending those messages to the store 140 or corresponding publisher service 110.

In some embodiments, the store 140 includes a recommendation engine 144. The recommendation engine determines relevance of products based on information in the products metadata data structure, as described in more detail below, and recommends one or more products based on the their relevance to the application 116 or to a purchase made by the IAP client 152 of the application 116.

According to various embodiments, the IAP client prompts a user of UE 101 to inquire into the availability for purchase of items related to the application 116 or previous purchases. The IAP client 152 corresponds with the IAP service 150 to determine one or more items in the products metadata data structure 148 that are related, as described in more detail below. The communication is either direct, or indirect through the store 140. Those related items are presented to the user by the IAP client. If one is selected for purchase, then a message is sent to the IAP service 150, which processes payment based on the payment information associated with the user in the consumer accounts data structure 146. In some embodiments, the user is authenticated using the authentication service 142. When the item is paid for, the IAP service 150 notifies the IAP client 152, which then downloads the item from the appropriate publisher service 110 to the UE 101. In some embodiments, the publisher service 110 verifies the transaction with the store 140 before allowing the download. In various embodiments, various payment options are available, such as a prepaid account, a credit card charge, and billing through the operator billing service 136, alone or in some combination. Thus, determining whether payment is arranged for a first item further comprises at least one of determining that a balance prepaid to the network service store is sufficient to cover a cost of the first item; determining that a credit card on file is valid for the cost of the first item; or determining that an operator is to bill the user for the cost of the first item. As stated above, the operator provides, for the user equipment, access to the communications network, e.g., through gateway 130; and the operator of gateway 130 is different from both the network service store 140 and the publisher that provide the registry service 120.

The IAP service 150 provides several advantages in various embodiments. One advantage of some embodiments is that the consumer who uses UE 101 is not prompted for redundant or inconsistent information to register with payment options for multiple publishers; and thus computational resources on the UE 101 are not wasted. Another advantage of some embodiments, in which several different applications use the same IAP service 150, is that the applications 116 and corresponding publisher services are freed from each consuming their own resources to perform the steps that can be performed by the IAP service 150 for all. Another advantage is that several different publishers can all use the same IAP service 150 to sell their products. The products metadata data structure merely indicates the publisher as well as the product in such embodiments. The IAP service 150 is an example means to achieve all these advantages.

Although depicted in FIG. 1 as integral process blocks or device blocks or data structure blocks of a particular number connected in particular ways for purposes of illustration, in other embodiments one or more processes, devices or data structures, or portions thereof, or in any combination, are arranged in a different order, in one or more databases, across one or more platforms connected directly or indirectly with each other though communications network 105. Furthermore, it is contemplated that the functions of these components may be combined in one or more components or performed by other components of equivalent functionality.

FIGS. 2A through 2E are diagrams of example data structures utilized to associate an application with items to be purchased through the application, according to one embodiment. Although data structures and fields therein are depicted in FIGS. 2A through 2E as integral blocks of storage arranged in a particular order for purposes of illustration, in other embodiments the data structures or fields, or portions thereof, are arranged in a different order or on one or more areas of storage or in one or more databases on one or more nodes of network 105, or one or more are omitted or one or more additional fields are included, or the data structures are changed in some combination of ways. In some embodiments, messages each of one or more data packets include one or more fields of the data structures depicted in FIGS. 2A through FIG. 2E.

FIG. 2A is a block diagram that illustrates a product entry data structure 200 for each product, according to an embodiment. The data structure 200 is a particular embodiment of the products data structure 122 of the publisher registry service 120 depicted in FIG. 1.

As each publisher offers products for purchase through one or more network service stores, such as store 140, information about the product is stored in data structure 200. Because multiple separately purchased features can be included with each product, in some embodiments, the data structure allows multiple items to be associated with each product. The data structure 200 includes a product identifier (ID) field 201, a product description field 202, an items list field 203, a service address field 208 and a promotion information field 209.

The product ID field 201 holds data that indicates the particular product, such as an publisher unique sequence number, or stock keeping unit (SKU) number, or universal product code (UPC), well known in the art. The description field 202 holds data that describes the product, such as a name, and one or more sentences of text.

The items list field 203 includes an item identifier (ID) field 205 and a cost field 206 and a description field 207 for every feature that can be purchased separately for the product, such as different levels of a game or a subscription service. Other items are indicated by ellipsis. In some embodiments, the first item in the items list field 203 is the overall product; and products that do not have a tiered cost structure include only one item in the items list 203. The item ID field 205 holds data that uniquely indicates the item within the product, such as with a sequence number. The cost field 206 holds data that indicates a cost, such as a multiple of a basic cost or an actual currency and amount. The description field 207 holds data that indicates a description of the item in sufficient detail for a consumer to determine whether to purchase the item.

The service address field 208 holds data that indicates a network address on the communications network 105 for the publisher service 110 that corresponds to the product, if any. In some embodiments, one or more of fields 202, 205, 206, 207 and 209 are available on the corresponding publisher service 110 and omitted from the publisher registry service 120.

The promotion information field 209 holds data that indicates a cost savings for certain conditions, e.g., during certain time intervals, in certain geographic regions or postal codes, for certain age groups, or if purchased with certain other products.

FIG. 2B is a block diagram that illustrates a subscriber profile data structure 210, according to an embodiment. The data structure 210 is a particular embodiment of an entry in the subscriber profiles data structure 112 of the subscription services 110a depicted in FIG. 1. In the illustrated embodiment, the data structure 210 includes an account ID field 211, an active flag field 213, an expiration date field 215, a billing information field 217, a subscriber information field 219, and a usage history field 221.

The account ID field 211 holds data that indicates a particular account for a subscriber. For example, the account ID field holds data that indicates a number that is incremented each time a new account is created for the subscription service.

The active flag field 213 holds data that indicates whether the account is active or not. In some embodiments, the active flag field 213 can also be used to indicate whether the account has not yet been used or has expired or has run out of funds. The expiration date field 215 holds data that indicates when the account is due to expire. If the account is not active, or if the account is ongoing (e.g., paid for by automatic bank or credit card payments), then in some embodiments, the expiration date field 215 holds a null value that indicates no expiration date.

The billing information field 217 holds data that indicates how the subscriber is to be billed, such as a paid balance amount, a paid duration, a bank account, a credit card, a billing address (mail or email), an identifier for an operator to be billed for the services or other information.

The subscriber information field 219 holds data that indicates a person who is the subscriber, such as a name, social security number, mailing address, email address, telephone number, and a list of user equipment associated with the same person.

The usage history filed 221 holds data that indicates use of the subscription service, such as songs downloaded and dates of download or dates signed on and duration of gaming sessions.

FIG. 2C is a block diagram that illustrates an example customer account data structure 230 for a network operator, according to an embodiment. The data structure 230 is a particular embodiment of an entry in the customer accounts data structure 132 of the operator gateway 130 depicted in FIG. 1. In the illustrated embodiment, the customer account data structure 230 includes customer identifier (BD) field 231, UE IDs field 233, status field 235, charges field 237 and customer information field 239.

The customer ID field 231 holds data that indicates the consumer who has purchased access to the communications network 105 through the operator which administers operator gateway 130. For example, an account number, email address or cellular telephone number is used as the customer ID in field 231.

The UE IDs field 233 holds data that indicates one or more pieces of equipment belonging to the customer indicated in field 231, such as the IMEI number of UE 101 and zero or more other pieces of equipment associated with the same customer.

The status field 235 holds data that indicates whether the customer account is active, suspended, paid up or in arrears. The charges field 237 holds data that indicates charges that the customer has accrued such as fixed monthly charges, and accrual of charges for other operator services, such as toll calls, text and data. In some embodiments, the charges field 237 also includes charges accrued on one or more subscription services 110a or applications or items thereof, which are billed through the operator, such as monthly or per song music downloads or game purchases and game level upgrades.

The customer information field 239 holds data that indicates information about the customer, such as name, social security number, mailing address, billing address, email, alternative telephone numbers, and payment information, such as credit card or bank accounts used for automatic payment.

FIG. 2D is a block diagram that illustrates an example products metadata data structure 250, according to an embodiment. The data structure 250 is a particular embodiment of an entry in the products metadata data structure 148 depicted in FIG. 1, for each product available for purchase through the store 140. In the illustrated embodiment, the products metadata data structure 250 includes a publisher field 251, a product ID field 253, a service address field 255, an item ID field 257, a context tokens field 259, and a content tokens field 261.

The publisher field 251 holds data that indicates the publisher, such as a network address for the publisher registry service 120. An advantage of the publisher field 251 is that the store 140, and IAP service 150, can support the purchase of applications for multiple publishers. In some embodiments, only one publisher is supported; and the publisher field 251 is omitted.

The product ID field 253 holds data, like in field 201, that indicates a particular product for the publisher indicated in field 251. The service address field 255 holds data, like in field 208, that indicates a network address on the communications network 105 for the publisher service 110 that correspond to the product, if any. The item ID field 257 holds data, like in field 205, that indicates a particular item associated with the product ID field.

In the illustrated embodiment, the products metadata data structure does not include other metadata about the product, such as fields 202, 206, 207 and 209. An advantage of excluding these fields is to save storage space for the data structure 140 and bandwidth keeping the values in these fields up to date as they change, when the same information can be retrieved from the publisher registry service 120 or the publisher service 110. In other embodiments, one or more of these fields are included in the data structure 250. An advantage of including one or all these fields is to save network resources to retrieve the information when requested by the IAP client 152 or service 150.

The context tokens field 259 holds data that indicates context that is associated with the item, such as geographic position or time of day for which the application item is appropriate, or the geographic regions or times, or some combination, of user equipment where the application item has been purchased or installed, or the names of persons on social networks who have purchased the item, or the name of applications running on user equipment when the item was purchased, any other context information that can be associated with the item indicated in field 257. Recall that some items refer to the overall product and not just a portion thereof. A token is a data structure that is capable of holding the desired information, such as a vector of context concepts, as described in more detail below.

Similarly, the content tokens field 261 holds data that indicates content associated with the item, such semantic concepts in one or more description of the product and the individual item. Recall that some items refer to the overall product and not just a portion thereof.

Any method may be used to indicate the context in field 259 or content in field 261. In various embodiments, a context vocabulary and topology is developed that identifies words and topics related to consumers' contexts. Any method known in the art may be used to generate the context vocabulary and topology. For example, several documents are collected that discuss and describe consumer context, such as documents that describe the significance of whether the consumer is working for pay or performing other duties or at leisure, whether the current time is a weeknight or weekend, whether the current season is summer or winter, whether the consumer is at home or away, or whether the consumer is at a destination or en route, whether a document is invoking a place name or a person name, whether the consumer is stationary or moving and at what speeds and directions, whether it is light or dark, and what applications are available on a user equipment belonging to the consumer. These documents are mined to determine words related to consumer context, collections of words related to context, or relative usage of those words, or some combination. In some embodiments, the vocabulary topology includes topics imposed on or deduced from relative occurrences of words within the documents. For example, in various embodiments, probabilistic latent semantic indexing (pLSI) or latent Dirichlet allocation (LDA), well known in the art, are used to deduce topics from words in a set of documents. Such methods can be used to derive context words and context topics from a set of documents that are directed to the circumstances of consumers of network services. Because each topic is associated with a group of words in certain relative abundances, there is a topology relating topics to words and subtopics to higher level topics. In some embodiments a context vocabulary is built manually or by relying on or extending some standard topology such as Open Directory Project (ODP) vocabulary. In these embodiments, LDA is not used in building the context vocabulary itself; but, once a vocabulary is established, documents can be mined using LDA to see what topics/context is contained within the document. The context vocabulary topology is used in various embodiments described herein to determine context for UE 101 and for items and products.

In some embodiments, there are only two levels of categories, e.g., topics and words, below the root level context vocabulary. Each topic is defined by a set of words, each with a particular range of occurrence percentages. In some of these embodiments, a vocabulary of V words is represented by a V-dimensional vector; and each word is represented by a V-dimensional vector with zeros in all positions but the position that corresponds to that particular word. Typically words of low meaning, such as articles, prepositions, pronouns and commonly used words are ignored. Each of T topics is represented by a V-dimensional vector with relative occurrences of each word in the topic represented by a percentage in the corresponding word positions. All topics are represented by a V×T matrix.

When a word from the context vocabulary is found in a document (e.g., a message from a user or a product description, e.g., in field 207), that word is considered a mixture of the different topics that include that word, with a percent probability assigned to each topic based on the percentage of words in the document, for example using the well known methods of LDA. As a result, the entire document can be represented by a set of topics found in the document with a probability metric assigned to each topic, e.g., a T-dimensional vector with varying probabilities in each position of the vector. Such a vector is an example of a context token herein. Two documents (such as a description of a product and a description of the current state of a UE 101) can be compared by computing a similarity of the two T-dimensional vectors (tokens) representing those documents, such as a sum of products of corresponding terms. Alternatively, or in addition, a distance metric can be computed between the two documents, which increases as the two tokens become less similar. Any distance metric can be used, such as an order zero distance (absolute value of the coordinate with the largest difference), an order 1 distance (a sum of the absolute values of the T differences,) an order two distance (a sum of the squares of the T differences—equivalent to the Euclidean distance), an order three distance (a sum of cubes of absolute values), etc. The more similar are tokens from two documents, or the smaller the distance between those tokens, the more relevant are the documents to each other. In the following description, it is assumed that a context vocabulary has been defined and is stored in a context vocabulary data structure. The context of a document or resource is represented by a context token. The more similar the context tokens of two documents, e.g., the smaller the distance measure between them, the more relevant one document is to the consumer context indicated by the other document.

Context is not obtained only from mining a user text base but more often directly on context data from the device. Thus, in some embodiments, context vocabulary is defined based on output from the context engine 104, which reflects all context that can be inferred from the device side, e.g., as user location, current activity, transport mode (in car, in bus, driving etc), relations (social contacts), abstracted locations such as home, work etc.

For purposes of illustration, it is assumed that there is a context vocabulary data structure (not shown) available to describe context. It is further assumed that there is a different, whole-language, semantic vocabulary data structure (not shown) for all concepts of a language, such as is used in modern search engines.

The context tokens field 259 is an example means to achieve the advantage of recommending items that apply to a user making a purchase through an application based on the context of the user equipment at the time of purchase. The content tokens field 261 is an example means to achieve the advantage of recommending items that are similar to an item being purchased through an application. In some embodiments, one or more of fields 259 or 61 are omitted. Omitting field 259 or field 261 is an example means of achieving the advantage of saving storage space for the products metadata data structure 148 and saving computational effort determining related items based on context or content or both.

FIG. 2E is a block diagram that illustrates an example store consumer account data structure 270, according to an embodiment. The data structure 270 is a particular embodiment of an entry in the store consumer account data structure 146 depicted in FIG. 1, for each consumer who has made a purchase at the store 140. In the illustrated embodiment, the store consumer account data structure 270 includes a consumer identifier (ID) field 271, a status field 273 a consumer information field 275, a charges field 277, a billing information field 279, a social networking information field 281, and, for each item purchased, a product ID field 283, an item ID field 285, a payment status field 287, and a receipt field 289. In some embodiments, such as embodiments that support multiple different publishers, a publisher field (not shown), like field 251, is also included for each item purchased.

The consumer ID field holds data that indicates the consumer who purchases applications through the store 140. The status field 273 holds data that indicates the status, e.g. active, suspended, paid in full, in arrears, etc. The consumer information field 275 holds data about the consumer, such as name, mailing address, email address, etc. In some embodiments, some or all of the information in field 275 is obtained from the operator gateway customer accounts data structure 132, e.g., based on the UE ID number of UE 101 through which the consumer registered with the store 140.

The charges field 277 holds data that indicates the charges accrued by the user during purchases, such as the cost of one or more applications or other products purchased. The billing information field 279 holds data that indicates how the charges are to be paid, e.g., from a prepaid account, through operator billing 136, or credit card information for a particular credit card to be charged.

The social networking field 281 holds data related to one or more social networking sites for the user, such as the email addresses or social network user names of one or more contacts of the consumer. The social network information field 281 is an example means to achieve the advantage of determining context for a user based on the purchases of persons socially connected to the user.

The product ID holds data, like field 201, that indicates a product purchased, such as application 116. The item field 285 holds data, like field 205 or field 257, that indicates a particular item of the product purchased, such as the first three levels of a game. The payment status field 287 holds data that indicates whether the charges for the item have been paid or are still due. The receipt field 289 holds data that indicates proof of payment for the item, which can be redeemed by the user to retrieve the product or item from the corresponding subscriber service 110, as described in more detail below. The ellipsis indicates repeats of fields 283, 285, 287 and 289 for other product items that have been purchased by the consumer. Fields 283, 285, 267 constitute a purchase history for the consumer that is an example means to achieve the advantages of accumulating billing charges and determining social context for a product. The receipt field is an example means to achieve the advantage of being able to verify a purchase by the consumer when questioned by a publisher service 110.

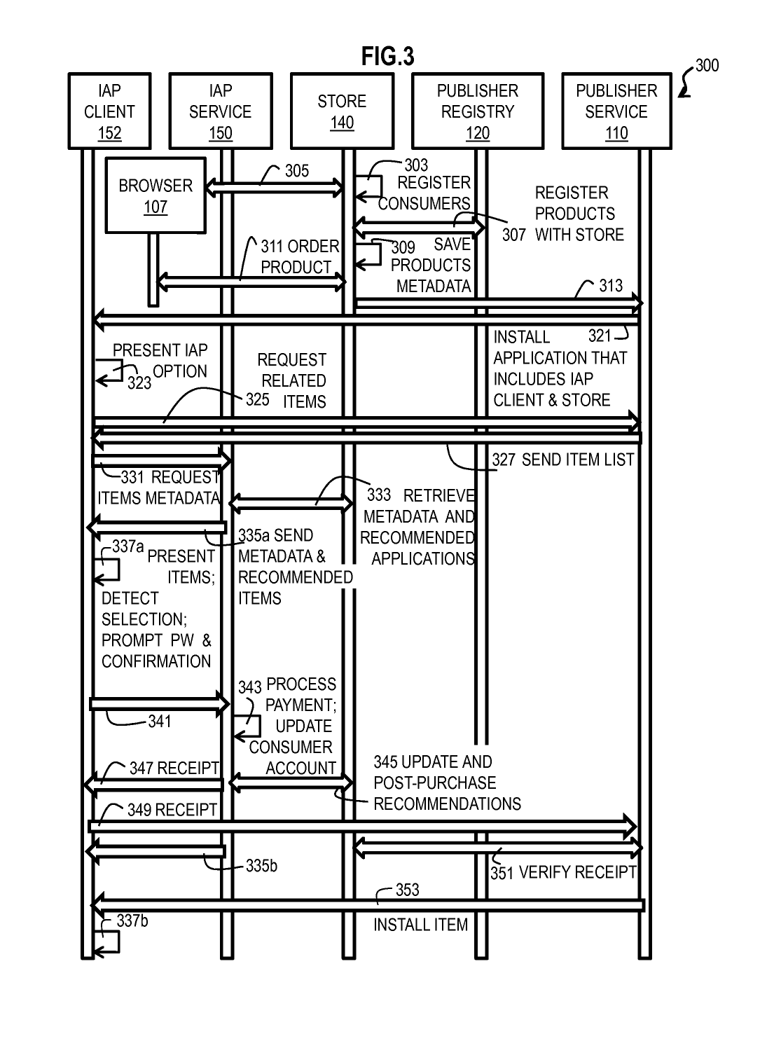

FIG. 3 is a time sequence diagram that depicts a sequence 300 of messages and actions at various processes in a communication network for in-application purchasing, according to one embodiment. Time increase downward in this diagram. Each of several interacting processes is represented by a vertical bar labeled by a box at the top of the bar. A message sent from one process to another is depicted as a horizontal arrow from the sending process to the receiving process. A step performed within one process is indicated by an arrow starting and ending on the same bar at a vertical position indicating its temporal sequence. The processes involved in the sequence 300 include the IAP client 152 and the browser 107 on the user equipment, the IAP service 150 and the store 140, as well as the publisher registry service 120 and one of the publisher services 110.

In process 303 the store 140 registers one or more consumers who purchase products through the store. During process 303, one or more messages 305 are exchanged with the browser 107 on UE 101 to register a user of UE 101 as a consumer of products from the store 140. The store 140 saves the consumer information in the consumer accounts data structure 146.

Meanwhile, one or more messages 307 are exchanged between the store 140 and a publisher registry 120, so that the store 140 is aware of the products and items for sale from the publisher. In process 309, the store 140 saves the product metadata in the products metadata data structure 148. To avoid cluttering the diagram, only one publisher registry 120 is depicted. It is understood that in some embodiments, multiple publisher registries register their products and features as items with the same store 140.

The browser 107 exchanges one or more messages 311 with the store 140 to order a product from the store, as is well known in the art. For purposes of illustration it is assumed that the consumer has ordered application 116. In the illustrated embodiment, the store 140 sends a message 313 to the publisher service 110 corresponding to application 116, authorizing the download of application 116 to the UE 101. In one or more messages 321, the application is downloaded and installed on the UE 101; and as a consequence, an icon indicating the application 116 appears on a display device of the UE 101. To avoid cluttering the diagram, the UE 101 and application 116 are not depicted. In the illustrated embodiment, the messages 321 include data that indicates the store 140 where the application was purchased. In some other embodiments, the store 140 is identified, e.g., by its network address, in one or more data structures on UE 101 filled by browser 107 during the exchange of messages 305 or 311 or both.

The application includes IAP client 152. When the application is launched by the user, e.g., by selecting the icon with a pointing device such as a touch screen, the IAP client 152 performs process 323 to present the user with an IAP option to purchase an item from within the application 116.

If the IAP option is selected by the user, then the IAP client 152 sends one or more messages 325 to request the items relevant to the application. As used herein, an item includes a feature of the application sending the request or another application or browser-based subscription service of the same or different publisher or a feature thereof. In the illustrated embodiment, the request messages are sent to the publisher service 110 that downloaded the application, since this information is available at the UE 101. In some embodiments, the request message 321 is directed to the IAP service 150 indicated in the messages 321, or to the store 140, which forwards the message to the publisher service 110 that corresponds to the application 116. The network address of the publisher service 110 is known to the store 140 and IAP service 150 based on an association indicated, for example, in product metadata data structure 250. In some embodiments where all fields of the product entry data structure 200 are on the products data structure 122 of the publisher registry service 120, the request is forwarded to the publisher registry service 120 instead of to the publisher service 110.

In one or more messages 327, a list of items related to the application is sent to the TAP client 152. For example, a list of item IDs are sent in messages 327. In some embodiments, the products metadata data structure 148 has sufficient information to determine the items that represent features of the current application 116, and messages 325 and 327 are omitted.

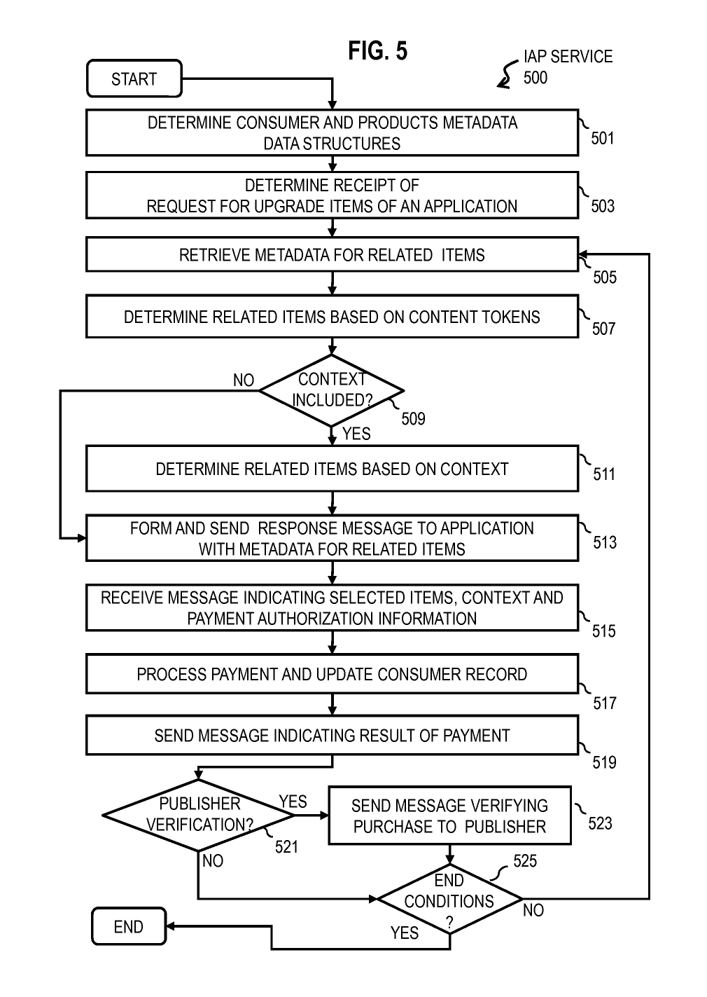

In the illustrated embodiment, the IAP client 152 obtains metadata about the items from the IAP service 150 by sending one or more messages 331 requesting metadata for the items to the IAP service 150. In one or more messages 333, the IAP service 150 obtains not only metadata about the items associated with the application, e.g. in product entry data structure 200, but also related items of different recommended products from the same or different publisher. The recommendation is based on similarity of content or context, as described in more detail below, with reference to FIG. 5. In some embodiments, all the metadata, including cost and descriptions of each item are stored in product metadata data structure 148 at store 140. In some embodiments, at least some of the metadata, such as cost and descriptions of each item, are stored in a different data structure elsewhere on the network, e.g., in product entry data structure 200 at publisher registry service 120 or at publisher service 110; and one or more messages (not shown) are exchanged with these services.

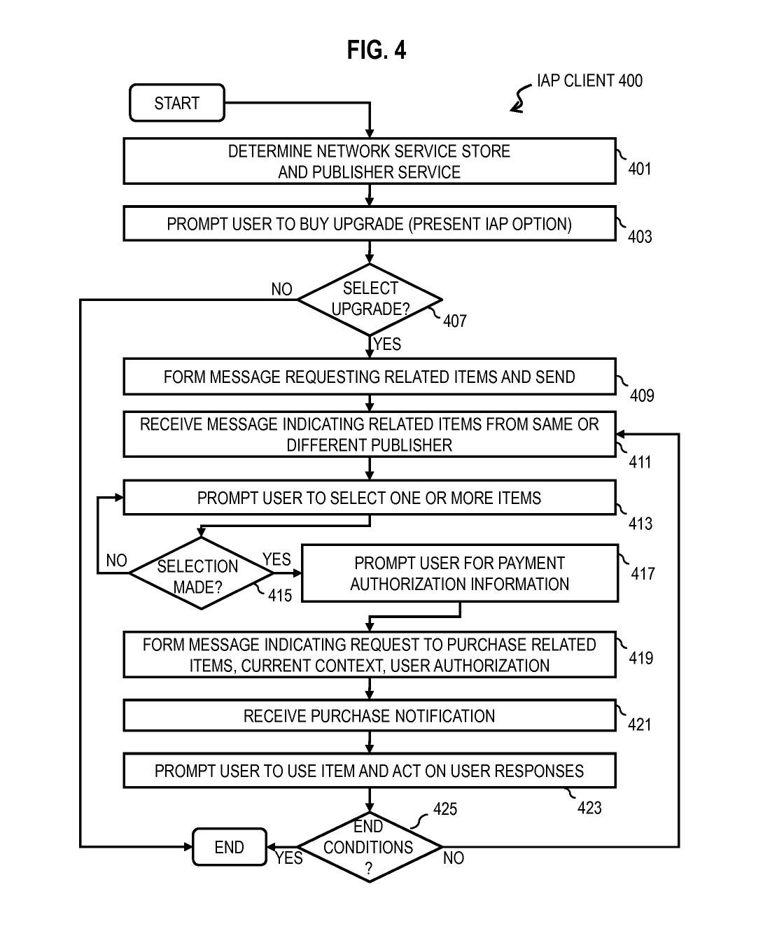

In one or more messages 335a, the metadata for the related items (including metadata for features of the application 116 and recommended features of other products of the same or different publishers) are sent to the IAP client 152. In process 337a, the related items are presented to the user, the user is prompted to make a selection, the selection is detected, and the user is prompted for any password desired and is prompted to confirm the purchase, as described in more detail below with reference to FIG. 4.

One or more messages 341 are sent to the IAP service 150. The messages 341 indicate the item selected for purchase, the password, and the confirmation to purchase. In process 343, the IAP service 150 processes the payment and updates the consumer account by exchanging one or more messages 345 with the store 140 or updating the consumer accounts data structure 146 directly. A successful payment results in a receipt that can be used to redeem the purchased item. The messages 345 indicate the updated purchase history and, if successful, a receipt, which is added to the consumer account data structure 146. Based on the latest purchase, the IAP service 150 also uses messages 345 to invoke the recommendation engine 144 to recommend one or more relevant items of the same or different publishers.

Thus, process 343 includes determining at a network service store (in service 150 of store 140) that a first message (e.g., message 341) is received through a communications network from an application (e.g., IAP client 152 in application 116) on user equipment 101. The first message indicates a first item to be purchased. A publisher (e.g., publisher service 110) different from the network service store has granted approval to use the application on the user equipment (e.g., in messages 321). Process 343 further includes determining at the network service store whether payment is arranged from a user of the user equipment to pay for the first item.

In one or more messages 347, the receipt is sent to the IAP client 152. In one or more messages 349, the receipt is sent from the IAP client 152 to the publisher service 110 to download the purchased item, e.g., the extra feature of the application 116. In one or more messages 351, the publisher service 110 verifies the receipt with the store 140. If verified, the publisher service 110 then downloads approval to use the item in one or more messages 353. In some embodiments, the messages 353 include only approval to use software that is already in the application 116. In some embodiments, the messages 353 include software instructions to add to the application 116 or for a different application with implicit approval to use it. Thus, if payment is arranged, the store 140 causes, at least in part, actions that result in approval from the publisher to use the first item on the user equipment (e.g., in one or more messages 353).

In messages 335b, like message 335a described above, the metadata for related items (including recommended products for the same or differ publisher) based on post-purchase relevance are sent to the IAP client 152. In process 337b, like process 337a described above, the related items are presented to the user, the user is prompted to make a selection, the selection is detected, and the user is prompted for any password desired and to confirm the purchase, as described in more detail below with reference to FIG. 4.

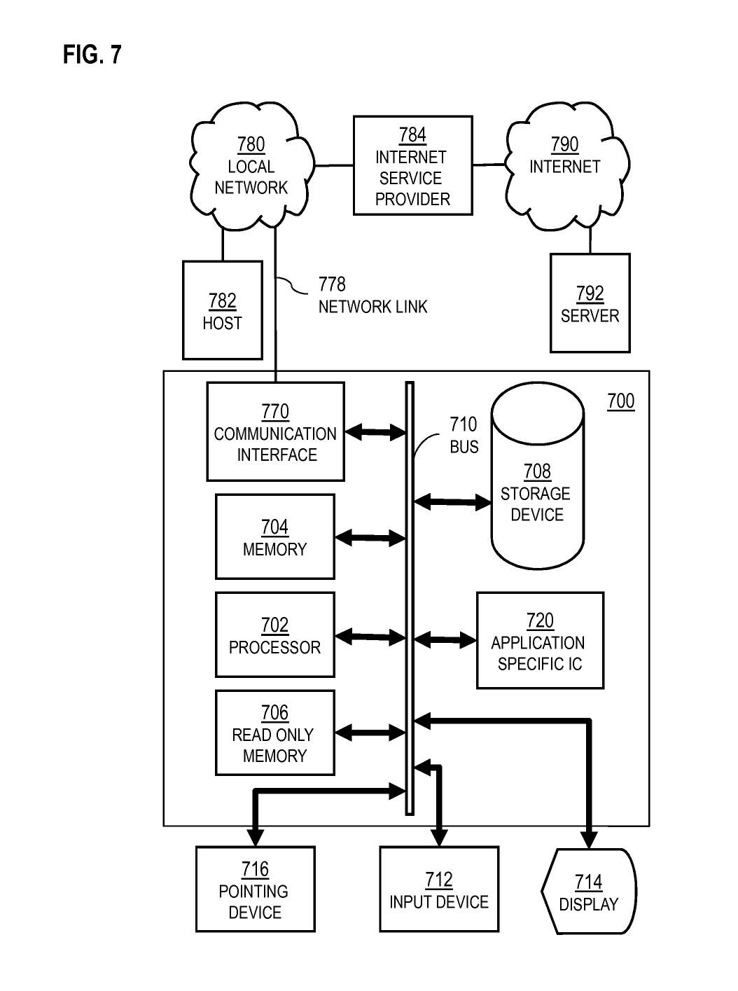

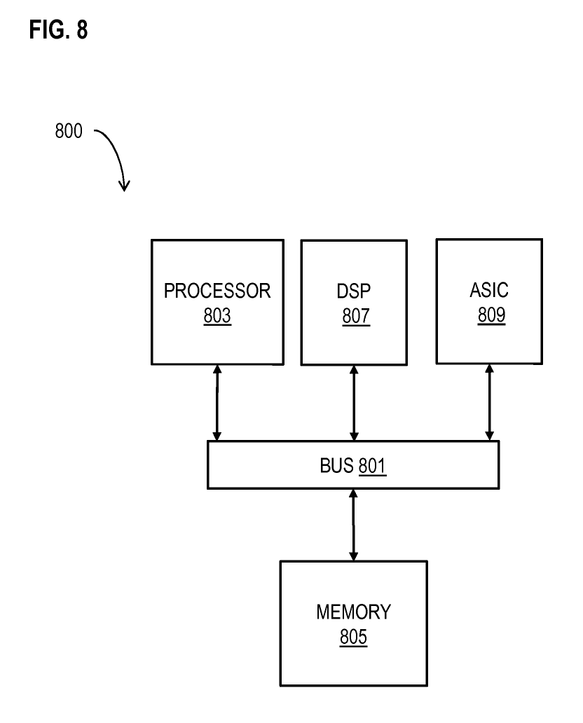

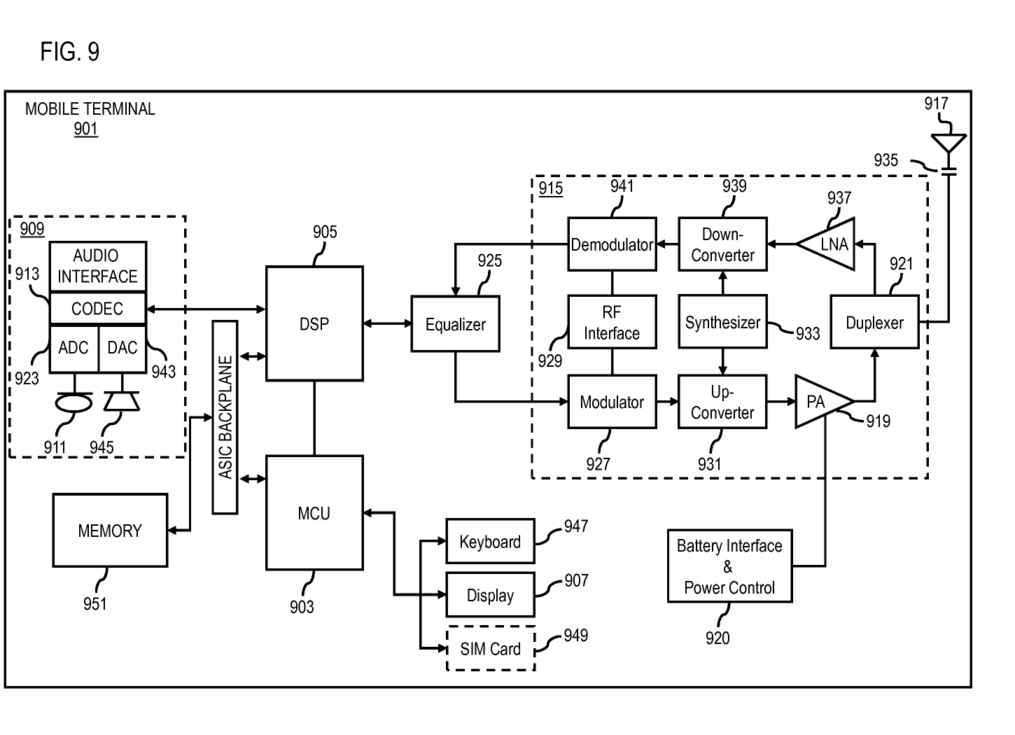

FIG. 4 is a flowchart of a process 400 on an IAP client, according to one embodiment. In one embodiment, the IAP client 152 performs the process 400 and is implemented in, for instance, a chip set including a processor and a memory as shown in FIG. 8 or mobile terminal as depicted in FIG. 9. In some embodiments, the application 116 or browser 107 performs one or more steps of process 400 and is implemented in, for instance, a chip set including a processor and a memory as shown in FIG. 8 or general purpose computer system as depicted in FIG. 7. Although steps are depicted in FIG. 4 and subsequent flowchart FIG. 5 as integral steps performed in a particular order for purposes of illustration, in other embodiments, one or more steps, or portions thereof are performed in a different order or overlapping in time, in series or in parallel, or one or more steps or portions are omitted, or other steps added, or the process is changed in some combination of ways.

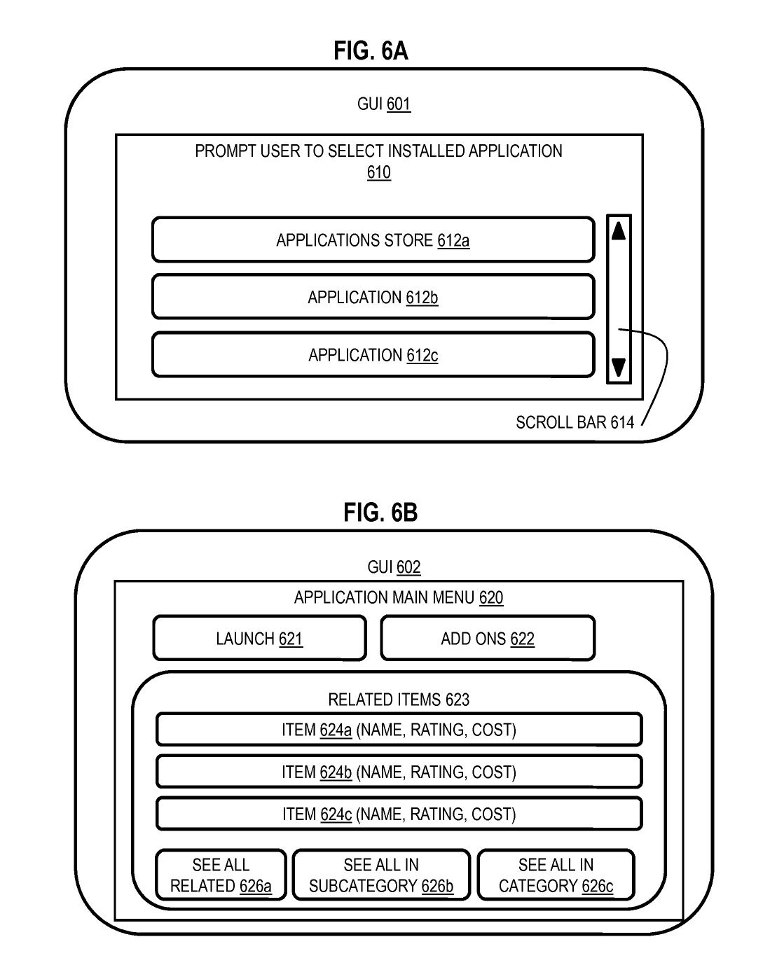

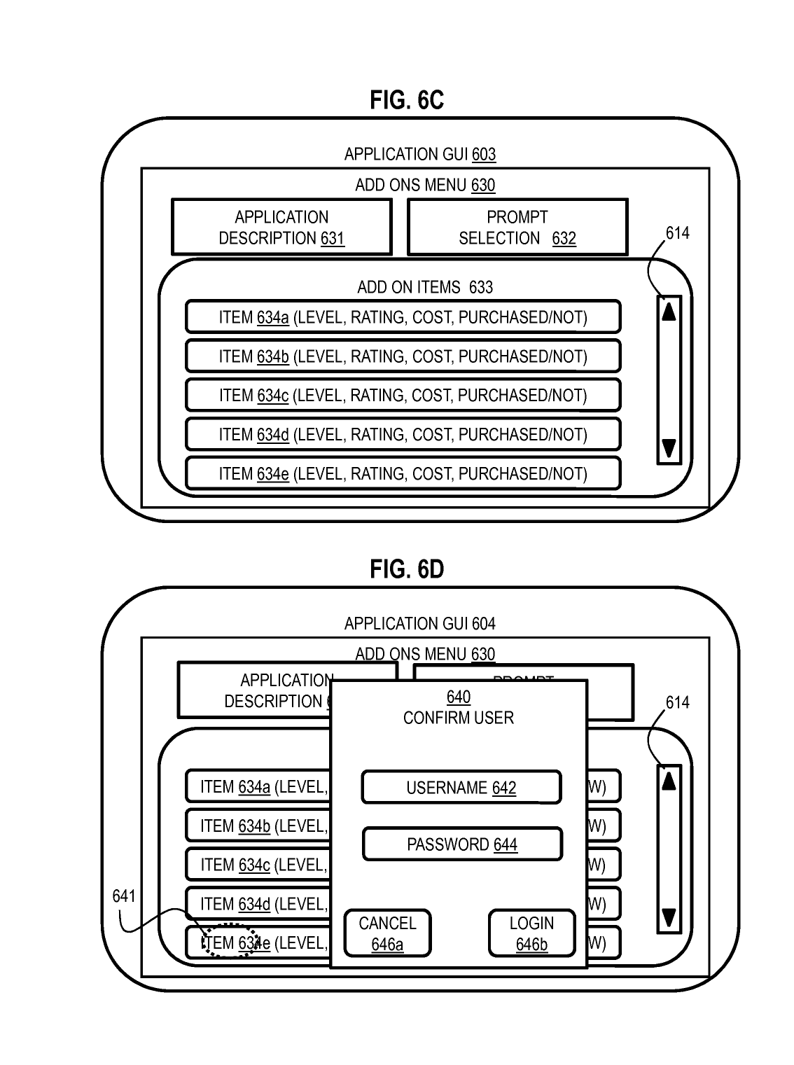

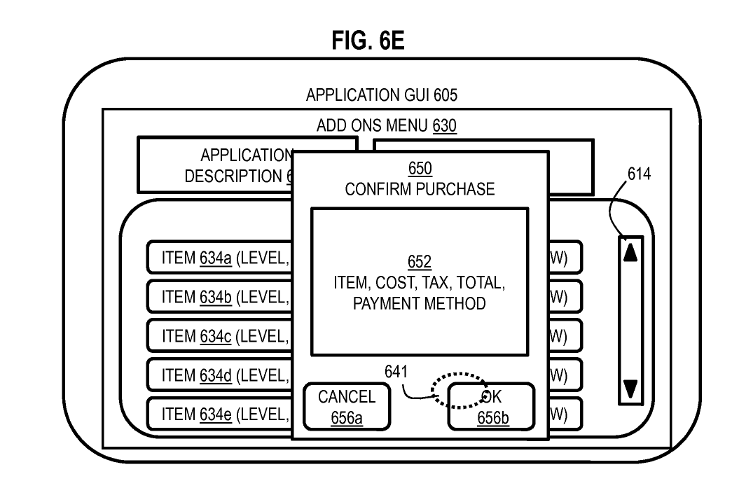

The steps of process 400 are performed after launching an application that includes an IAP client. An application is typically launched from a graphical user interface (GUI). FIGS. 6A-6D are diagrams of user interfaces utilized in the processes of FIG. 4, according to various embodiments.

FIG. 6A is a block diagram of an example graphical user interface (GUI) 601 presented on a display device of UE 101, according to one embodiment. A graphical user interface presents rows and columns of pixels that display text and images and is configured to determine when an active area of pixels are indicated by a user using a pointing device, such as a touch screen or cursor positioning device and selection keys, as is well known in the art. Any active areas may be included in various embodiments of the GUI, such as a text box, buttons, radio buttons, scroll bars, pull down menus, among others, well known in the art.

The UE GUI 601 includes a prompt text area 610 and active areas 612a through 612c (collectively referenced hereinafter as active areas 612). The prompt text area 610 presents text that prompts a user to select one of the active areas, e.g., to select an installed application or to visit the application store to obtain additional applications. Active area 612a is selected to visit the application store (e.g., communicate via browser 107 with the store 140). One of active areas 612b and 612c is selected to launch the application indicted by text or graphic or both in the active area 612. In embodiments with more installed applications than can be displayed at one time in area 610, a scroll bar 614, well known in the art, is included to allow active areas to launch other applications to be moved into and out of the viewing area of the GUI 601. The interaction with the store 140 and installation of one or more applications are performed as in messages 305, 311, 313 and 312, described above with reference to FIG. 3.

After launch of application 116, the IAP client 152 within the application 116 becomes active. In step 401, the network service store 140 and publisher service 110 are determined. For example, the IAP client 152 reads the network address of the store 140 and publisher service 110 returned in messages 321, described above, and stored in a particular register or other particular memory location on the UE 101. Memory is described in more detail below with reference to FIG. 7 and FIG. 8. Any method may be used to determine the values for the particular register of memory location. In some embodiments, the values are included as default values in software instructions. Software instructions are described in more detail below with reference to FIG. 7. In various embodiments, the values are requested or received as manual input from a network service administrator on the local or a remote node, are retrieved from a local file or database, or are sent from a different node on the network, e.g., in message 321, either in response to a query, e.g., message 311, or unsolicited, or the values are received using some combination of these methods.

In step 403 the user is prompted to purchase an upgrade for the application 116 by presenting the IAP option. For example, text or image or both are presented in a browser 107, or an icon representing the subscription client appears on a display of the UE, or a graphical user interface of the application 116 or IAP client 152 produces an image or text or both. For example, the IAP client 152 presents a graphical user interface 602 depicted in FIG. 6B.

FIG. 6B is a block diagram of an example graphical user interface (GUI) 602 presented on a display device of UE 101, according to another embodiment. The GUI 602 includes an application main menu area 620. The application main menu area 620 includes a launch application active area, an add ons active area 622 and a related items active area 623.

The launch active area 621, when activated by a user operating a pointing device, causes the application 116 as it is currently configured to execute on the UE 101. The add ons area 622, when activated by a user operating a pointing device, causes a list of additional features that are available for purchase for the current application. The related items area 623 includes one or more active areas 624a, 624b, 624c (collectively referenced hereinafter as related items active areas 624) for different items (applications and browser-based subscription services) related to the current application, as described in more detail below. In some embodiments, all the related items cannot be displayed in the available related items area 623 and an active area 626a labeled “see all related items,” is included. In some embodiments, items in the same category (e.g., games) or subcategory (e.g., strategy games) are also listed separately through the IAP client. In these embodiments, the related items area 623 includes an active area 626b labeled “see all items in subcategory” (wherein the subcategory is named, e.g., “strategy games”) or an active area 626c labeled “see all items in category” (wherein the category is named, e.g., “games”), or both. In response to pressing these buttons another GUI (not shown, but similar to FIG. 6C described below) is presented with active areas for all the items that satisfy the button label.

In some embodiments, the related items are determined based on a purchase history of the user during execution of the application; and initially area 623 is empty, in whole or in part. For example, active areas 624 are absent and active areas 626a, 626b and 626c (collectively referenced hereinafter as active areas 626) are grayed over, to indicate the areas are not currently active, and cannot be selected. For purposes of illustration, it is assumed that, during step 403, the related items area 623 is not active.

In step 407, it is determined whether the user has chosen to view the add on features by selecting the add ons active area 622. If not, the IAP client process ends. Otherwise, in step 409, a message (e.g., message 325) is formed and sent requesting the relevant items. In some embodiments, the message is sent to the store 140, which forwards the message to the IAP service 150, for determining the items based on the products metadata data structure 148. In the illustrated embodiment, the request relevant items message (e.g., message 325) is sent to the publisher service 110 that corresponds to the application 116 (e.g., an application service 110b from which the application was downloaded or a corresponding subscription service 110a). That service 110 sends a list of the related items corresponding to features of the application 116 to the IAP client 152 that then sends the list of the related items in request message 331 to the IAP service 150 (directly or through the store 140). Thus, in the illustrated embodiment, step 409 includes exchanging messages 325, 327 and 331 depicted in FIG. 3.

In step 411, a message is received indicating related items from the same or different publisher. For example, after the IAP service 150 retrieves metadata for the list of related items from the product metadata data structure 148 or the publisher service 110 indicated therein or the publisher registry 140 for that publisher, or some combination, and after receiving one or more recommended items from the recommendation engine 144, message 335a is sent and received by the IAP client 152 during step 411. The message 335a indicates related items from the same or different publisher. In some embodiments, only the additional features that can be purchased for the current application 116 are returned unless and until a purchase is made.

Thus steps 409 and 411 together are one means for determining a plurality of items associated with the application. As indicated above, the application was purchased from a network service store; and a publisher different from the network service store has granted approval to use the application on the user equipment.

In step 413, the user is prompted to select one or more items. For example, during step 413, the user is prompted with the GUI of FIG. 6C. FIG. 6C is a block diagram of an example application GUI 603 presented on a display device of UE 101, according to one embodiment. The application GUI 603 includes an add ons menu area 630, which includes an application description area 631 and a prompt selection text area 632 and an add on items area 633.

The application description area 631 presents text or graphics, or both, which describes the application 116 to which the features listed are to be added. The prompt selection area 632 presents text that invites the user to select one or more items representing features to add to the current application, such as one or more levels to add to a game.

The add on items area 633 includes item active areas 634a, 634b, 634c, 634d, 634e (collectively referenced hereinafter as item active area 634). If there is not sufficient space in add on items area 633 for all items, a scroll bar 614 is included to control which item active areas 634 are presented within the acid on items area 633. Each item active area presents text or graphics or both that indicate a description of the add on item (e.g., one or more of a level name or number and a rating for the item), a cost of the item and a purchase status (e.g., one of “not available,” “not purchased” or “purchased”). A user indicates one or more items to be purchased by selecting the active areas 634. For other items listed in response to activating buttons 626 in main menu area 620, an active area similar to active area 633 is presented, where the items represents other products (or features thereof) from the same or different publisher.

Thus step 413 includes causing, at least in part, actions that result in presenting the plurality of items to a user of the user equipment.

In step 415, it is determined whether the user has made a selection. Thus step 415 includes determining whether the user has selected a first item of the plurality of items to purchase. For example, it is determined whether the user has used a pointing device to select an active area 634. If not, control passes back to step 413 to present the prompts (e.g., add ons menu 633). If so, then in step 417 the user is prompted for payment authorization information. For example, during step 417, the user is prompted with the GUI of FIG. 6D and FIG. 6E. FIG. 6D is a block diagram of an example GUI 604 presented on a display device of UE 101, according to one embodiment. The application GUI 604 includes a confirm user area 640. In the illustrated embodiment, the confirm user area 640 is superposed over the add ons menu 630, described above. In other embodiments, the confirm user area 640 appears alone in the application GUI 604 or appears over another area from which a purchase selection is made, e.g., over application main menu area 620.

The confirm user area 640 includes a username active area 642, a password active area 644, a cancel button 646a and a login button 646b. The confirm user area 640 is employed to determine whether the user is authorized to make a purchase at the store 140, e.g., is a registered consumer of the store 140. The username active area 642 is a text field in which the user can type the username for the user at the network service store 140. Similarly, the password active area 644 is a text field in which the user can type the password for the user at the network service store 140. After the text is filled in areas 642 and 644, the user may activate the login button 646b to proceed with the purchase. If the user instead activates the cancel button 646a, the user is returned to a previous GUI, e.g., GUI 602 with the application main menu area 620.

In some embodiments, one or more of the text fields in active areas 642 or 644 are filled automatically, during step 417, such as when the user has already logged in during the current execution of the application 116. In some embodiments, a password is always required to be entered in the active area 644, to ensure that a purchase is not made while a user is absent from the UE 101.

After activating the login button 646b, the user is presented with a confirm purchase GUI. FIG. 6E is a block diagram of an example GUI 605 presented on a display device of UE 101, according to one embodiment. The application GUI 605 includes a confirm purchase area 650. In the illustrated embodiment, the confirm purchase area 650 is superposed over the add ons menu 630, described above. In other embodiments, the confirm purchase area 650 appears alone in the application GUI 605 or appears over another area from which a purchase selection is made, e.g., over application main menu area 620.

The confirm purchase area 650 includes a purchase summary area 652, a cancel button 656a and an OK button 656b. The purchase summary area includes text or graphics or both that indicate the item to be purchased, the cost of the item, any tax that applies, a total, and a payment method. The payment method is any used at the store, such as a prepaid account, a credit card or a bill from the operator, or some combination. If the user concurs with the purchase as summarized in area 652, then the user may activate the OK button 656b to proceed with the purchase. If the user instead activates the cancel button 646a, the user is returned to a previous GUI, e.g., the GUI 602 with the application main menu area 620.

In step 419, a message is formed and sent, e.g., message 341 is formed and sent to the IAP service 150 (either directly of through the store 140). The message indicates a request to purchase the selected item or items, and the user authorization credentials (e.g., username and password). Thus, step 419 includes causing, at least in part, actions that result in sending a message to the network service store if the user has selected the first item to purchase. The message indicates a request to purchase the first item. In some embodiments, the message also indicates the current context of the user equipment, e.g., with a context token derived from the output of the context engine 104.

In step 421 a purchase notification is received. For example, a message 347 is received with a receipt that can be used to redeem the item from the publisher service, if the purchase is successful, or an error message if the purchase is unsuccessful. If the purchase is successful, step 421 includes sending the receipt to the publisher service in message 349 and installing the item in one or more messages 353 from the publisher service 110.

In step, 423 the user is prompted to use the purchased item and the application acts based on user responses. For example, the application main menu 620 is presented, and the user may choose to launch the application by activating launch area 621 or exit the application and return to the GUI 601 where any newly installed applications are available for selection.

In step 425, it is determined if end conditions are satisfied. If so, the process ends. Otherwise, the process returns to step 411 to receive any further messages with relevant items.

For example, message 335b is received which indicates one or more post-purchase recommendations, such as applications or browser-based subscription services from the same or different publisher. As described in more detail below, additional items are recommended by the IAP service 150 based on the context or content (or both) of the purchased item, the context or content (or both) of the products available for purchase, and the recommendation engine 144. The recommended items are included in message 335b. Thus, at least during subsequent passes in some embodiments, step 411 includes determining that a message is received from the network service store, wherein the message indicates a different second item related to the first item. In some embodiments, the second item is related to the first item because the second item is associated with a similar semantic concept as associated with the first item. In some embodiments, the second item is related to the first item because the second item is associated with a similar context as associated with the user equipment during purchase of the first item.

In step 413 the user is prompted to select one or more of the recommended items, e.g., in related items area 623 of GUI 602. Thus, at least during subsequent passes in some embodiments, step 413 includes causing, at least in part, actions that result in presenting the second item on a user interface on the user equipment.

FIG. 5 is a flowchart of a process 500 in an IAP service, according to one embodiment. In some embodiments, the IAP service 150 performs one or more steps of process 500 and is implemented in, for instance, a chip set including a processor and a memory as shown in FIG. 8 or general purpose computer system as depicted in FIG. 7. In some embodiments, one or more steps are performed by the network service store 140, such as on a general purpose computer system as depicted in FIG. 7.

In step 501, data indicating consumers and products metadata are determined and stored in data structures. For example, messages 305 are exchanged with browsers on the user equipment of one or more consumers and consumer accounts are formed and stored in consumer accounts data structure 146. Also, messages 307 are exchanged with product registry services 120 of one or more publishers and products metadata are determined and stored in products metadata data structure 148. A difference with prior approaches is that the products include multiple items that represent features that can be purchased separately and incrementally for some products. Another difference is that, in some embodiments, context or content concepts, or both, are also stored in the products metadata data structure 148, e.g., in context tokens field 259 and content tokens field 261, respectively. Thus, in at least some embodiments, step 501 includes determining semantic concepts associated with a plurality of items available from one or more publishers different from the network service store. Similarly, in at least some embodiments, step 501 includes determining contexts associated with a plurality of items available from one or more publishers different from the network service store.

In step 503, it is determined that a request message is received, wherein the request message indicates an upgrade item for an application. For example, message 331 is received from IAP client 152 in application 116. The message 331 indicates a request for metadata about related items for application 116. In the illustrated embodiment, the message 331 is a result of IAP client 152 sending one or more messages 325 to the publisher service 110 requesting the publisher to list the relevant items (e.g., add on features of application 116); and IAP client 152 receiving a list of relevant items in one or more messages 327.

In some embodiments, step 503 includes an original order for an application, e.g., through the store 140. For example, a message 311 that orders a product is received at store 140 from browser 107, a payment is processed as usual, and a message is sent or caused to be sent to the publisher service where the product can be downloaded. The product is downloaded in one or more messages 321 with an indication of the store where upgrades can be purchased as well. Any method may be used to purchase the original product, including current approaches. A difference is that the product purchased and installed (e.g., application 116) includes the IAP client 152.

In step 505, metadata for the related items are retrieved. In some embodiments, the metadata all reside in the products metadata data structure 148 and is retrieved from there. In some embodiments, the products metadata data structure 250 includes the item ID and the publisher (e.g., in fields 257 and 251, respectively) and this is used by the IAP service 150 to request the item cost and description from the fields 206 and 207 of product entry data structure 200 at the publisher registry service 120. In some embodiments, the products metadata data structure 250 includes the item ID and service address (e.g., in fields 257 and 255, respectively) and this is used by the IAP service 150 to request the item cost and description from the publisher service 110.

In step 507, additional related items are determined based on the content for one or more of the items requested in step 503 or indicated in a purchase message received in step 515, described in more detail below. For example, the recommendation engine 144 compares the content of the application being upgraded or the item being purchased to the content tokens in field 261 of the product metadata data structure 250 for one or more items. The items of sufficient content similarity are added to the related items. In some embodiments, step 507 includes determining other items in the same category or subcategory, or both, as the product being upgraded or selected for purchase or both. In some embodiments, the categories and subcategories of the application are considered semantic concepts of the application. Thus, step 507 includes determining a first semantic concept associated with the first item; and determining a different second item (i.e., a related item) associated with a second semantic concept similar to the first semantic concept associated with the first item.

In some embodiments, step 507 is omitted until after a purchase is requested in step 515.

In step 509 it is determined whether the message received in step 503 requesting available upgrades, or the message received in step 515 requesting a purchase, includes context information, e.g., from context engine 104. If not, then step 511 is skipped. If so, then in step 511 additional related items are determined based on the context of the user equipment. For example, the recommendation engine 144 compares the context of the user equipment to the context tokens in field 259 of the product metadata data structure 250 for one or more items. The items of sufficient context similarity are added to the related items. Thus, step 511 includes determining a first context associated with the user equipment; and determining a different second item (i.e., a related item) associated with a second context similar to the first context.

For example, if one or more promotions are related to the user equipment context (time of day, geographic area, age of user etc.) then the similarity of context tokens for that item will be high, and the item will be included in related items. As another example, in some embodiments, the context of a request includes one or more contacts from a social network of the user, as determined in field 281 of consumer account entry data structure 270. If one or more items have been purchased by many of the user's contacts, then the similarity of the context token for that user will be high, and the item will be included in the related items. Thus, in some embodiments, context associated with the plurality of items includes one or more identifiers of consumers who have purchased the item and the first context includes an identifier of a social network contact of the user of the user equipment. In some embodiments, step 511 is omitted until after a purchase is requested in step 515. Thus, determining a first context associated with the user equipment further comprising determining the first context based on context information included in a second message from the user equipment. In some embodiments the second message with context information is different from the first message requesting related items. In other embodiments, the second message with context information is the same as the first message requesting related items.

In step 513, a response message is formed and sent. The response message indicates the metadata, such as cost and description, for the related items, including any in the same category or subcategory. For example, message 335a is sent with metadata for requested application upgrades and recommended items, if any. In some embodiments, recommendations are not made until after a purchase decision is made by the user; and message 335a excludes recommended items. The purchase decision is made in a second message from the user equipment received in step 515. In some embodiments, the use of application 116 is considered a purchase choice and one or more recommended items are included in message 335a. The related items in the message sent in step 513 are presented to the user by the IAP client 152. Thus step 513 causes, at least in part, actions that result in presenting the second item (i.e., a related item) on a user interface on the user equipment.

In step 515 a purchase message is received from the IAP client. In the illustrated embodiment, the purchase message indicates a selected item to be purchased, context data indicating the context of the user equipment at the time the purchase message is sent, and payment authorization information, such as username and password (the latter often encrypted). For example, message 341 is received from the IAP client 152 during step 515. Step 515 satisfies the attempted purchase condition for including content and context related items in subsequent passes through steps 507, 509 and 511.

In step 517, the payment is processed; and, if successful, the consumer record is updated to indicate the item purchased, and the receipt is issued for redeeming the item. In some embodiments, the context tokens field 259 for the purchased item is also updated with the social network name of the purchaser or the user equipment context at the time of the purchase or both. The update is done directly by the IAP service 150 in some embodiments, or indirectly through the store 140 using one or more of messages 345 in other embodiments.

In step 519 a result message is sent to the IAP client 152. The result message indicates the result of the purchase, such as a receipt used to redeem the item or an error message explaining why the purchase failed. Example error messages include “lack of payment information,” “invalid or expired credit card,” “depleted prepaid balance,” among others. For example, result message 349 is sent with a receipt.

In step 521, it is determined whether a publisher verification message is received. In some embodiments, a publisher service 110 checks a receipt received from an IAP client 152 by sending it to the store 140, e.g., in message 351. If a publisher verification message is received, then in step 523 it is determined whether the receipt matches the receipt in the store consumer accounts data structure 146 (e.g., in field 270 of data structure 270) for the purchased item indicated in field 285. A message verifying or denying the receipt is then sent to the publisher service 110 during step 523. The steps 521 and 523 are performed by the store 140 in some embodiments; and performed by the IAP service 150 in some other embodiments.

In step 525, it is determined if end conditions are satisfied. If so, the process ends. Otherwise control passes back to step 505 to retrieve metadata for items related to the item indicated in message received during step 515. On subsequent passes through steps 507, 509 and 511, recommended items are included in the response message sent to the IAP client 152, in the illustrated embodiment. In some embodiments, items other than the items representing features of a selected application are not recommended based on content or context.

The processes described herein for in-application purchasing may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to extend duration of a subscription service bundled with user equipment as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of in-application purchasing.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to in-application purchasing. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for in-application purchasing. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for in-application purchasing, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USE) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for extending duration of a subscription service bundled with the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to extend duration of a subscription service bundled with user equipment as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of in-application purchasing. Chip set or chip 800, or a portion thereof, constitutes a means for performing one or more steps of in-application purchasing.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to extend duration of a subscription service bundled with user equipment. The memory 805 also stores the data associated with or generated by the execution of the inventive steps.

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of in-application purchasing. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of in-application purchasing. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to extend duration of a subscription service bundled with user equipment. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining at a network service store that a first message is received through a communications network from an application on a user equipment, wherein the first message indicates a first item to be purchased, and wherein the first item belongs to a publisher different from the network service store;
determining at the network service store whether payment is arranged from a user of the user equipment to pay for the first item; and
if payment is arranged, then causing, at least in part, actions that result in approval from the publisher to use the first item on the user equipment.

2. A method according to claim 1, wherein receiving from the publisher a granted approval to use the application on the user equipment.

3. A method according to claim 1, wherein determining whether the payment is arranged further comprises at least one of:
determining that a balance prepaid to the network service store is sufficient to cover a cost of the first item;
determining that a credit card on file is valid for the cost of the first item; or
determining that an operator is to bill the user for the cost of the first item, wherein the operator provides, for the user equipment, access to the communications network, and the operator is different from both the network service store and the publisher.

4. A method according to claim 1, further comprising:
determining semantic concepts associated with a plurality of items available from one or more publishers different from the network service store;
determining a first semantic concept associated with the first item;
determining a different second item associated with a second semantic concept similar to the first semantic concept associated with the first item;
causing, at least in part, actions that result in presenting the second item on a user interface on the user equipment.

5. A method according to claim 4, wherein the second item is one of a different application of the publisher or a different application of a different publisher.

6. A method according to claim 1, further comprising:
determining contexts associated with a plurality of items available from one or more publishers different from the network service store;
determining a first context associated with the user equipment;
determining a different second item associated with a second context similar to the first context;
causing, at least in part, actions that result in presenting the second item on a user interface on the user equipment.

7. A method according to claim 6, wherein determining a first context associated with the user equipment further comprising determining the first context based on context information included in a second message from the user equipment.

8. A method according to claim 7, wherein the second message is the same as the first message.

9. A method according to claim 6, wherein the second item is one of a different application of the publisher or a different application of a different publisher.

10. An apparatus comprising:
at least one processor; and
at least one memory including computer program code for one or more programs,
the at least one memory and the computer program code configured to, with the at least one processor, cause the apparatus to perform at least the following,
determine one or more items associated with the program, wherein the one or more items belong to publishers different from a network service store;
cause, at least in part, actions that result in presenting the one or more items to a user of the apparatus;
determine whether the user has selected a first item of the one or more items to purchase; and
if the user has selected the first item to purchase, then cause, at least in part, actions that result in sending a message to the network service store, wherein the message indicates a request to purchase the first item.

11. An apparatus according to claim 10, wherein a granted approval to use the program on the apparatus is received from the publisher.

12. An apparatus according to claim 10, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

13. An apparatus as according to claim 10, further comprises a user interface, wherein the apparatus is further configured to:
determine to present a second item from the network service store on the user interface, wherein the semantic concept of the second item is similar to the semantic concept of the first item.

14. An apparatus as according to claim 13, wherein the second item is one of a different application of the publisher or a different application of a different publisher.

15. An apparatus as according to claim 10, further comprises a user interface, wherein the apparatus is further configured to:
determine to present a second item from the network service store on the user interface, wherein the context associated with the second item is similar to the context associated with the apparatus.

16. An apparatus according to claim 15, wherein the second item is one of a different application of the publisher or a different application of a different publisher.

17. An apparatus comprising:
at least one processor; and
at least one memory including computer program code for one or more programs,
the at least one memory and the computer program code configured to, with the at least one processor, cause the apparatus to perform at least the following,
determine that a first message is received through a communications network from an application on a user equipment, wherein the message indicates a first item to purchase, and wherein the first item belongs to a publisher different from a network service store;
determine whether payment is arranged from a user of the user equipment to pay for the first item; and
if payment is arranged, then cause, at least in part, actions that result in approval from the publisher to use the first item on the user equipment.

18. An apparatus as according to claim 17, wherein a granted approval to use the application on the user equipment is received from the publisher.

19. An apparatus according to claim 17, wherein the apparatus is further caused to:
determine semantic concepts associated with one or more items;
determine a first semantic concept associated with the first item;
determine a different second item among the one or more items, and the second item is associated with a second semantic concept similar to the first semantic concept associated with the first item;
cause, at least in part, actions that result in presenting the second item on a user interface on the user equipment.

20. An apparatus according to claim 19, wherein the second item is one of a different application of the publisher or a different application of a different publisher.
